(19) United States
(12) Patent Application Publication
(10) Pub. No.: US 2024/0328214 A1
(43) Pub. Date: Oct. 3, 2024

(54) Door Lock of Recreational Vehicle

(71) Applicant: Dongguan Jufu Metal Manufactory Co., Ltd, Dongguan (CN)

(72) Inventor: Yuming Chen, Hongjiang (CN)

(21) Appl. No.: 18/738,000

(22) Filed: Jun. 8, 2024

(30) Foreign Application Priority Data
Apr. 28, 2024 (CN) 202420897152.5

(51) Int. Cl. E05B 81/14; E05B 81/06; E05B 81/56; E05B 81/82

(52) U.S. Cl. CPC E05B 81/14; E05B 81/06; E05B 81/56; E05B 81/82

(57) ABSTRACT

Disclosed is a door lock of a recreational vehicle, comprising an exterior panel, a lock body and an interior panel, wherein a first sliding cavity, a second sliding cavity and a driving cavity are formed in the lock body, a slidable deadbolt and a slidable latch bolt are arranged in the first sliding cavity and the second sliding cavity respectively, a motor and a rotatable spindle are mounted in the driving cavity, a first gear is mounted on an output shaft of the motor, and an eccentric rod is arranged on an upper surface of the first gear. The door lock eliminates all drive designs related to driving levers and hinge bars, and adopts gear drive on the whole, thus being more stable in operation and reducing the failure rate.

### BACKGROUND OF THE INVENTION

### Technical Field

The invention relates to the technical field of door locks, in particular to a door lock of a recreational vehicle.

### Description of Related Art

It is commonly known that recreational vehicles are popular vehicles introduced from abroad, and are equipped with household equipment including bedding, cookware, refrigerators, cabinets, sofas, dining tables and chairs, toilet sets, air conditioners, televisions, sound equipment, and other furniture and electric appliances, and may be divided into a driving area, a living area, a bedroom area, a washroom area, a kitchen area, etc., thus being popular products that can provide basic necessities of life to allow users to travel in life and to live in travel and being mobile vehicles equipped with essential basic household equipment. The door, particularly the lock on the door, of the recreational vehicles is different from that of conventional vehicles.

At present, the internal driving structure of most existing door locks of recreational vehicles realizes driving based on a driving lever, a hinge bar, or the linkage of a driving rod, a hinge bar and a gear. However, on the one hand, such a drive structure increases the design requirement for the internal space of the door lock and leads to an excessively large size of the door lock, which is not beneficial to the compact design of the door lock; and on the other hand, a gap is likely to be formed between the driving lever and the hinge bar after the driving lever and the hinge bar are connected, leading to driving faults or other problems and even causing failures to unlock when the recreational vehicles run or vibrate. The direct use of an all-gear drive can guarantee the stability of driving. However, how to make the all-gear drive structure occupy a small space and synchronously drive a latch bolt (a safety deadbolt) is a problem to be solved nowadays.

### BRIEF SUMMARY OF THE INVENTION

In view of the abovementioned defects existing in the prior art, the objective of the invention is to provide an all-gear-drive door lock of a recreational vehicle, which occupies a small space.

To fulfill the above objective, the invention adopts the following technical solution:

A door lock of a recreational vehicle comprises an exterior panel mounted on a door of a recreational vehicle, a lock body and an interior panel, wherein the lock body is located between the exterior panel and the interior panel, a first sliding cavity, a second sliding cavity and a driving cavity are formed in the lock body, a slidable deadbolt and a slidable latch bolt are arranged in the first sliding cavity and the second sliding cavity respectively, a motor and a rotatable spindle are mounted in the driving cavity, a first gear is mounted on an output shaft of the motor, and an eccentric rod is arranged on an upper surface of the first gear;

wherein, a strip-shaped sliding slot is formed in an inner end of the latch bolt, the eccentric rod is inserted into the strip-shaped sliding slot, and the other end of the latch bolt stretches out of or retracts into the lock body with forward or reverse rotation of the first gear; a horizontal line is defined by a center of the first gear, and after the latch bolt stretches out of the lock body, the eccentric rod is located below the horizontal plane, and the motor functions as a limit component for preventing the first gear from further rotating; a second gear is arranged on the spindle and meshes with the first gear, and one end of the spindle is arranged on the interior panel and provided with a rotary handle;

at least one spring is arranged between one end of the deadbolt and a bottom of the first sliding cavity, and under the action of the spring, the other end of the deadbolt keeps stretching out of the lock body; an exterior handle is hinged and connected to the exterior panel, an interior handle is hinged to the interior panel, a recess is formed in the deadbolt, driving levers are arranged on the exterior handle and the interior handle respectively, and top ends of the driving levers are inserted into the recess of the deadbolt; and when the exterior handle or the interior handle is rotated, the corresponding driving lever pushes the deadbolt to retract into the lock body.

Preferably, a via hole is formed between the first sliding cavity and the second sliding cavity, a stop pin capable of rolling freely is mounted in the via hole, a clamping groove is formed in a side edge of the deadbolt, and an arc-shaped slide is arranged on a side of the latch bolt; when an inlet of the arc-shaped slide is connected to the via hole, a lower half of the stop pin rolls into the arc-shaped slide to make the stop pin disengages from the clamping groove; and when the latch bolt stretches out of the lock body, the arc-shaped slide will gradually lift the stop pin to allow the stop pin to be clamped in the clamping groove again.

Preferably, the stop pin is cylindrical or spherical.

Preferably, an opening is formed in the other end of the spindle, two interconnected 90° mortises are formed in the opening, a lock cylinder is arranged on the exterior panel, a rotating portion of the lock cylinder is connected to the opening of the spindle, and two bulges flush with each other are arranged on the rotating portion of the lock cylinder and received in the 90° mortises.

Preferably, a circuit mainboard is arranged on the exterior panel or the interior panel; a fingerprint recognition module and a password key module, which allow the motor to be started to work after passing recognition, are integrated on the exterior panel; a battery holder, allowing a battery mounted thereon to be replaced, is arranged on the interior panel; and the fingerprint recognition module, the password key module, the battery holder and the motor are all electrically connected to the circuit mainboard.

Preferably, a receiving cavity is formed in the exterior panel corresponding to the exterior handle to allow the exterior handle to be received therein, and a gap for a hand to be inserted therein is reserved between a grip portion of the exterior handle and an inner wall of the receiving cavity.

Preferably, the motor is a gear motor with a reduction gear box.

Preferably, the battery mounted on the battery holder is a rechargeable battery, the circuit mainboard is provided with a charging port, and a receptacle of the charging port is arranged outside.

By adopting the above technical solution, the door lock provided by the invention eliminates all drive designs related to driving levers and hinge bars, and adopts gear drive on the whole, thus being more stable in operation and reducing the failure rate; moreover, after the latch bolt stretches out of the lock body, the eccentric rod for controlling the movement of the latch bolt is located below the horizontal line to be effectively prevented from rotating reversely under the action of gravity even in case of vibrations, thus ensuring that the latch bolt can stretch out stability; in addition, the motor functions as a component for preventing the eccentric rod from further rotating downwards during the vibration process, such that the eccentric rod can be limited without the design of redundant components, thus satisfying the requirement for a compact design.

### BRIEF DESCRIPTION OF THE SEVERAL VIEWS OF THE DRAWINGS

FIG. 1 is a perspective structural view of a front side according to an embodiment of the invention.

FIG. 2 is a perspective structural view of a back according to an embodiment of the invention.

FIG. 3 is an exploded structural view according to an embodiment of the invention.

FIG. 4 is a structural view of a lock body according to an embodiment of the invention.

FIG. 5 is a structural view of the joint of a motor and a latch bolt according to an embodiment of the invention.

FIG. 6 is a structural view of the joint of the motor and the latch bolt from another perspective according to an embodiment of the invention.

FIG. 7 is a structural view of the connection of a spindle and a lock cylinder according to an embodiment of the invention.

### DETAILED DESCRIPTION OF THE INVENTION

To better clarify the objectives, technical solutions and advantages of the invention, the invention is described in further detail below in conjunction with accompanying drawings and embodiments. It should be understood that the specific embodiments described here are merely used for explaining the invention, and are not intended to limit the invention.

In the description of the invention, it should be understood that terms “center”, “longitudinal”, “transverse”, “length”, “width”, “thickness”, “upper”, “lower”, “front”, “back”, “left”, “right”, “vertical”, “horizontal”, “top”, “bottom”, “interior”, “exterior”, “clockwise” and “anticlockwise” are used to indicate directional or positional relations based on the accompanying drawings merely for the purpose of facilitating and simplifying the description of the invention, do not indicate or imply that devices or elements referred to must be in a specific direction or be configured and operated in a specific direction, and thus should not be construed as limitations of the invention. In addition, terms “first” and “second” are merely used for the purpose of description and should not be construed as indicating or implying relative importance or the number of technical features referred to. Therefore, a feature defined by “first” or “second” may explicitly or implicitly indicate the inclusion of one or more said features. In the description of the invention, “multiple” means one or more, unless otherwise expressly defined.

In the description of the invention, it should be noted that, unless otherwise expressly stated and defined, terms “mount”, “link” and “connect” should be broadly understood. For example, “connect” may refer to fixed connection, detachable connection or integrated connection; or, mechanical connection or electrical connection; or, direct connection, indirect connection by means of an intermediate medium, or internal connection or interaction of two elements. Those ordinarily skilled in the art can appreciate the specific meanings of these terms in the invention as the case may be.

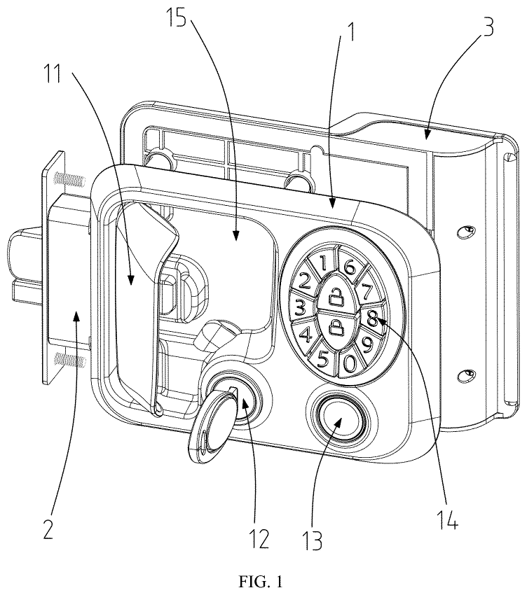

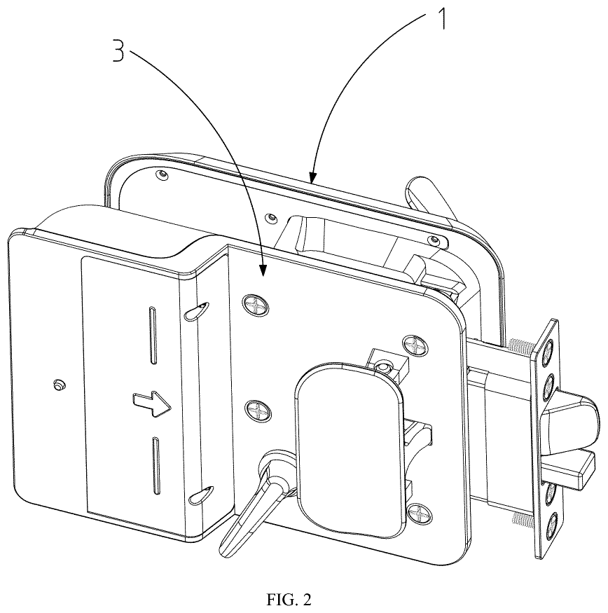

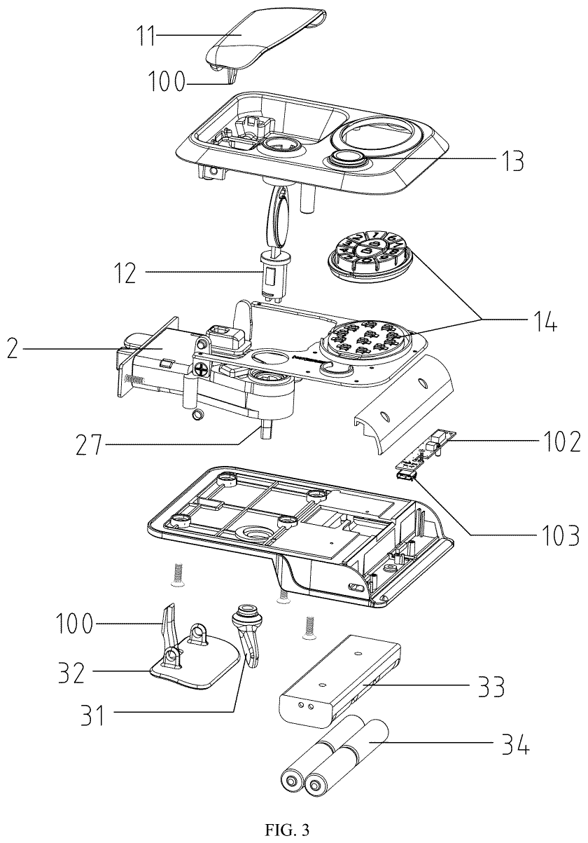

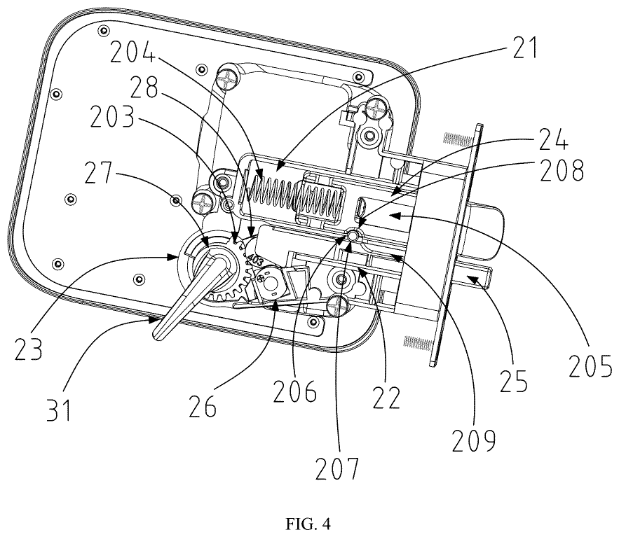

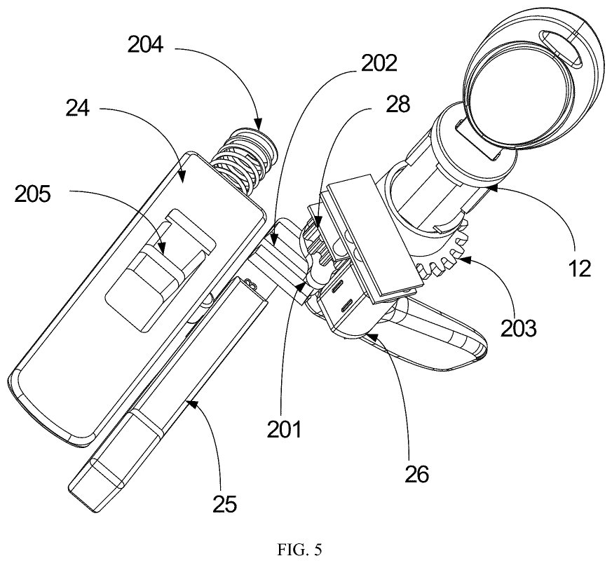

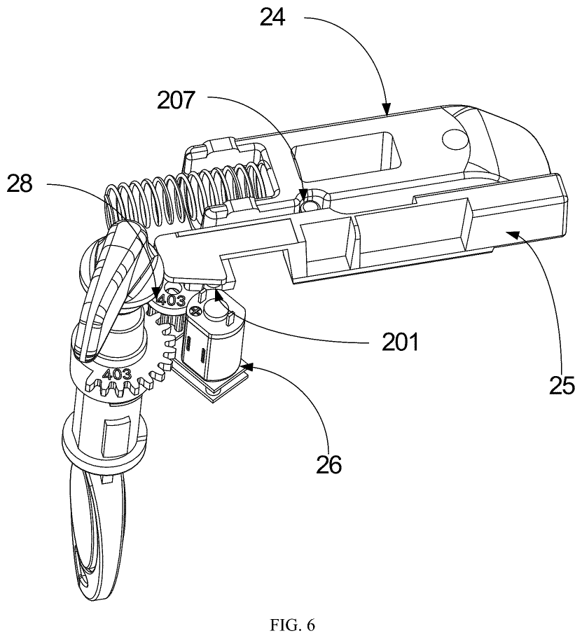

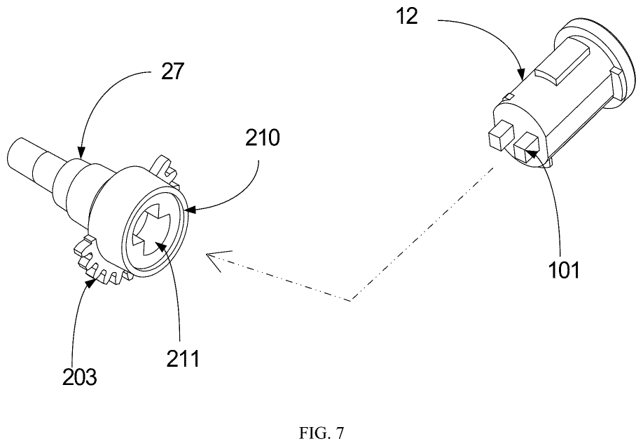

As shown in FIG. 1-FIG. 7, this embodiment provides a door lock of a recreational vehicle, comprising an exterior panel 1 mounted on a door of a recreational vehicle, a lock body 2 and an interior panel 3, wherein the lock body 2 is located between the exterior panel 1 and the interior panel 3, a first sliding cavity 21, a second sliding cavity 22 and a driving cavity 23 are formed in the lock body 2, a slidable deadbolt 24 and a slidable latch bolt 25 are arranged in the first sliding cavity 21 and the second sliding cavity 22 respectively, a motor 26 and a rotatable spindle 27 are mounted in the driving cavity 23, a first gear 28 is mounted on an output shaft of the motor 26, an eccentric rod 201 is arranged on an upper surface of the first gear 28, and the motor 26 is a gear motor provided with a reduction gear box, such that the driving stability of the motor 26 is improved.

Wherein, a strip-shaped sliding slot 202 is formed in an inner end of the latch bolt 25, the eccentric rod 201 is inserted into the strip-shaped sliding slot 202, and the other end of the latch bolt 25 stretches out of or retracts into the lock body 2 with forward or reverse rotation of the first gear 28; a horizontal line is defined by the center of the first gear 28, and after the latch bolt 25 stretches out of the lock body 2, the eccentric rod 201 is located below the horizontal plane, and the motor 26 functions as a limit component for preventing the first gear 28 from further rotating; a second gear 203 is arranged on the spindle 27 and meshes with the first gear 28, and one end of the spindle 27 is arranged on the interior panel 3 and provided with a rotary handle 31.

At least one spring 204 is arranged between one end of the deadbolt 24 and the bottom of the first sliding cavity 21, and under the action of the spring 204, the other end of the deadbolt 24 keeps stretching out of the lock body 2; an exterior handle 11 is hinged and connected to the exterior panel 1, an interior handle 32 is hinged to the interior panel 3, a recess 205 is formed in the deadbolt 24, driving levers 100 are arranged on the exterior handle 11 and the interior handle 32 respectively, and top ends of the driving levers 100 are inserted into the recess 205 of the deadbolt 24; and when the exterior handle 11 or the interior handle 32 is rotated, the corresponding driving lever 100 pushes the deadbolt 24 to retract into the lock body 2.

The door lock in this embodiment eliminates all drive designs related to driving levers and hinge bars, and adopts gear drive on the whole, thus being more stable in operation and reducing the failure rate. Moreover, after the latch bolt 25 stretches out of the lock body 2, the eccentric rod 201 for controlling the movement of the latch bolt is located below the horizontal line to be effectively prevented from rotating reversely under the action of gravity even in case of vibrations, thus ensuring that the latch bolt 25 can stretch out stability. In addition, the motor 26 functions as a component for preventing the eccentric rod 201 from further rotating downwards during the vibration process, such that the eccentric rod 201 can be limited without the design of redundant components, thus satisfying the requirement for a compact design.

During specific operation, the latch bolt 25 does not stretch out by default; when the latch bolt 25 needs to be stretched out (the door lock needs to be locked), the motor 26 drives the first gear 28 to rotate clockwise, at this moment, the eccentric rod 201 moves in the strip-shaped sliding slot 202 and synchronously pushes the latch bolt 25 outwards until one end of the latch bolt 25 is pushed out of the lock body 2, and the eccentric rod 201 moves to a position below the horizontal line according to the setting, such that the door lock is locked. When the door lock needs to be unlocked, the motor 26 just needs to drive the first gear 28 to rotate anticlockwise, and then the latch bolt 25 can retract into the lock body 2, such that the door lock is unlocked.

Further, to better guarantee the safety and prevent the exterior handle 11 or the interior handle 32 from being shifted before unlocking, in this embodiment, a via hole 206 is formed between the first sliding cavity 21 and the second sliding cavity 22, a stop pin 207 capable of rolling freely is mounted in the via hole 206, a clamping groove 208 is formed in a side edge of the deadbolt 24, and an arc-shaped slide 209 is arranged on a side of the latch bolt 25; when an inlet of the arc-shaped slide 209 is connected to the via hole 206, a lower half of the stop pin 207 rolls into the arc-shaped slide 209 to make the stop pin 207 disengage from the clamping groove 208; and when the latch bolt 25 stretches out of the lock body 2, the arc-shaped slide 209 will gradually lift the stop pin 207 to allow the stop pin 207 to be clamped in the clamping groove 208 again. In this way, the stop pin 207 can prevent the deadbolt 24 from moving to prevent the exterior handle 11 or the interior handle 32 from being shifted, such that users can know that the door lock has been locked when the exterior handle 11 or the interior handle 32 cannot be shifted.

Further, to allow the stop pin 207 to roll more smoothly, in this embodiment, the stop pin 207 is cylindrical or spherical.

Further, because the lock needs to be unlocked with a key when necessary, an opening 210 is formed in the other end of the spindle 27, two interconnected 90° mortises 211 are formed in the opening 210, a lock cylinder 12 for unlocking the lock with a key is arranged on the exterior panel 1, a rotating portion of the lock cylinder 12 is connected to the opening 210 of the spindle 27, and two bulges 101 flush with each other are arranged on the rotating portion of the lock cylinder 12 and received in the 90° mortises 211. By means of the two interconnected 90° mortises 211 arranged in the spindle 27, the lock cylinder 12 can rotate within 180°; the lock cylinder 12 is unlocked after being rotated anticlockwise by 90°, returns to original point to allow the key to be pulled out after being rotated reversely by 90°, and is locked after being rotated clockwise by 90°; and when the lock cylinder 12 is located at the original position to allow the key to be pulled out, the other 90° mortise 211 is used for locking and unlocking the latch bolt 25 in linkage with the motor. In this way, the lock cylinder 12 and the motor 26 can be unlocked separately without mutual interference.

Further, to allow the door lock to be unlocked in multiple ways, in this embodiment, a circuit mainboard 102 is arranged on the exterior panel 1 or the interior panel 2; a fingerprint recognition module 13 and a password key module 14, which allow the motor 26 to be started to work after passing recognition, are integrated on the exterior panel 1; a battery holder 33, allowing a battery 34 mounted thereon to be replaced, is arranged on the interior panel 3; and the fingerprint recognition module 13, the password key module 14, the battery holder 33 and the motor 26 are all electrically connected to the circuit mainboard 102. Wherein, the door lock can be unlocked with a key, a fingerprint or a password.

Further, to protect the exterior handle 11 against damage, in this embodiment, a receiving cavity 15 is formed in the exterior panel 1 corresponding to the exterior handle 11 to allow the exterior handle 11 to be received therein, and a gap for a hand to be inserted therein is reserved between a grip potion of the handle 11 and an inner wall of the receiving cavity 15.

Further, in this embodiment, the battery 34 mounted on the battery holder 33 is a rechargeable battery, the circuit mainboard 102 is provided with a charging port 103, and a receptacle of the charging port 103 is arranged outside. In this way, when running out of electricity, the battery 34 can be replaced or directly charged by users flexibly in different cases.

In addition, it should be noted that in this embodiment, other gears may be added between the motor 26 and the first gear 28, as well as between the first gear 28 and the second gear 203 according to design requirements, and this embodiment has not limitation in the addition of gears.

The above embodiments are merely preferred ones of the invention, and are not intended to limit the patent scope of the invention. All equivalent structures or flow transformations made based on the contents in the description and accompanying drawings of the invention, or direct or indirect applications to other related technical fields should also fall within the patent protection scope of the invention.

What is claimed is:

1. A door lock of a recreational vehicle, comprising an exterior panel mounted on a door of a recreational vehicle, a lock body and an interior panel, wherein the lock body is located between the exterior panel and the interior panel, a first sliding cavity, a second sliding cavity and a driving cavity are formed in the lock body, a slidable deadbolt and a slidable latch bolt are arranged in the first sliding cavity and the second sliding cavity respectively, a motor and a rotatable spindle are mounted in the driving cavity, a first gear is mounted on an output shaft of the motor, and an eccentric rod is arranged on an upper surface of the first gear;
wherein, a strip-shaped sliding slot is formed in an inner end of the latch bolt, the eccentric rod is inserted into the strip-shaped sliding slot, and the other end of the latch bolt stretches out of or retracts into the lock body with forward or reverse rotation of the first gear; a horizontal line is defined by a center of the first gear, and after the latch bolt stretches out of the lock body, the eccentric rod is located below the horizontal plane, and the motor functions as a limit component for preventing the first gear from further rotating; a second gear is arranged on the spindle and meshes with the first gear, and one end of the spindle is arranged on the interior panel and provided with a rotary handle;
at least one spring is arranged between one end of the deadbolt and a bottom of the first sliding cavity, and under the action of the spring, the other end of the deadbolt keeps stretching out of the lock body; an exterior handle is hinged and connected to the exterior panel, an interior handle is hinged to the interior panel, a recess is formed in the deadbolt, driving levers are arranged on the exterior handle and the interior handle respectively, and top ends of the driving levers are inserted into the recess of the deadbolt; and when the exterior handle or the interior handle is rotated, the corresponding driving lever pushes the deadbolt to retract into the lock body.

2. The door lock of a recreational vehicle according to claim 1, wherein a via hole is formed between the first sliding cavity and the second sliding cavity, a stop pin capable of rolling freely is mounted in the via hole, a clamping groove is formed in a side edge of the deadbolt, and an arc-shaped slide is arranged on a side of the latch bolt; when an inlet of the arc-shaped slide is connected to the via hole, a lower half of the stop pin rolls into the arc-shaped slide to make the stop pin disengages from the clamping groove; and when the latch bolt stretches out of the lock body, the arc-shaped slide will gradually lift the stop pin to allow the stop pin to be clamped in the clamping groove again.

3. The door lock of a recreational vehicle according to claim 2, wherein the stop pin is cylindrical or spherical.

4. The door lock of a recreational vehicle according to claim 1, wherein an opening is formed in the other end of the spindle, two interconnected 90° mortises are formed in the opening, a lock cylinder is arranged on the exterior panel, a rotating portion of the lock cylinder is connected to the opening of the spindle, and two bulges flush with each other are arranged on the rotating portion of the lock cylinder and received in the 90° mortises.

5. The door lock of a recreational vehicle according to claim 1, wherein a circuit mainboard is arranged on the exterior panel or the interior panel; a fingerprint recognition module and a password key module, which allow the motor to be started to work after passing recognition, are integrated on the exterior panel; a battery holder, allowing a battery mounted thereon to be replaced, is arranged on the interior panel; and the fingerprint recognition module, the password key module, the battery holder and the motor are all electrically connected to the circuit mainboard.

6. The door lock of a recreational vehicle according to claim 1, wherein a receiving cavity is formed in the exterior panel corresponding to the exterior handle to allow the exterior handle to be received therein, and a gap for a hand to be inserted therein is reserved between a grip portion of the exterior handle and an inner wall of the receiving cavity.

7. The door lock of a recreational vehicle according to claim 1, wherein the motor is a gear motor with a reduction gear box.

8. The door lock of a recreational vehicle according to claim 5, wherein the battery mounted on the battery holder is a rechargeable battery, the circuit mainboard is provided with a charging port, and a receptacle of the charging port is arranged outside.
